(19) United States
(12) Patent Application Publication
(10) Pub. No.: US 2006/0021774 A1
(43) Pub. Date: Feb. 2, 2006

(54) Shell structure for server

(75) Inventors: Lung-Sheng Tsai, Taipei City (TW); Yi-Lung Chou, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 11/041,238

(22) Filed: Jan. 25, 2005

(30) Foreign Application Priority Data
Jul. 30, 2004 (TW) 093212127

(51) Int. Cl. H02G 3/08

(52) U.S. Cl. 174/50

(57) ABSTRACT

Disclosed is a shell structure for server, which includes a right-side cover shell, and a left-side cover shell. The right-side cover shell has a front panel perpendicularly extended from the front side thereof toward the left side and an opening formed in the front panel, the left-side cover shell is covered on the right-side cover shell and has a mounting panel perpendicularly extended from the front side thereof toward the right side and a detachable baffle detachably fastened to the mounting panel with a screw to block the opening in the mounting panel of the left-side cover shell and the opening in the front panel of the right-side cover shell such that an interface card can directly be installed inside the left-side cover shell after removal of the detachable baffle from the mounting panel.

### BACKGROUND OF THE INVENTION

1. Field of the Invention

The present invention relates to a server and more particularly, to a shell structure for server, which enables the user to install an interface card inside the shell structure conveniently without removing the ornamental plate.

2. Description of Related Art

Similar to a regular host computer, a server has installed therein a variety of electronic devices such as motherboard, CPU, chips, cooling devices, and etc.

Further, the motherboard of a server may be mounted with a number of interface cards, each interface card having at least one connection port for connection to an external apparatus.

FIG. 1 is a perspective view of a server according to the prior art. According to this design, a server 91 has a shell 911 and a front panel 92 at the front side of the shell 911. FIG. 2 is perspective view showing another status of the prior art, which shows the server 91 after installation of an interface card. As illustrated, a front panel 93, which has an opening 931, is installed in the front side of the shell 911 to substitute for the front panel 92 shown in FIG. 1.

When wishing to install inside the server 91 an interface card 94 having connection ports 941, the user must remove the front panel 92 without opening shown in FIG. 1 from the shell 911, and then install the interface card 94 inside the server 91, and then fasten the front panel 93 shown in FIG. 2 to the shell 911, keeping the connection ports 941 exposed to the outside through the opening 931 of the front panel 93. Because a different front panel must be used after installation of an interface card, the installation cost and the working time is greatly increased.

### SUMMARY OF THE INVENTION

The present invention has been accomplished under the circumstances in view. It is therefore the main object of the present invention to provide a shell structure for server, which eliminates the drawback of the aforesaid prior art design. According to the preferred embodiment of the present invention, the shell structure for server comprises a right-side cover shell and a left-side cover shell. The right-side cover shell defines a receiving open chamber. Further, the right-side cover shell has a front panel perpendicularly extended from the front side thereof toward the left side, and an opening formed in the front panel. The left-side cover shell is covered on the right-side cover shell to close the receiving open chamber, having a mounting panel perpendicularly extended from the front side thereof toward the right side. The mounting panel has an opening corresponding to the opening in the front panel of the right-side cover shell. The left-side cover shell further comprises a detachable baffle, which is detachably fastened to the mounting panel to block the opening in the mounting panel of the left-side cover shell and the opening in the front panel of the right-side cover shell. Therefore, the design of providing the mounting panel of the left-side cover shell with a detachable baffle can be modularized and applicable to any of a variety types of servers. Further, it is not necessary to detach the front panel of the right-side cover shell during installation of an interface card. The detachable baffle directly blocks the opening of the left-side cover shell and the opening of the right-side cover shell. After removal of the detachable baffle from the mounting panel of the left-side cover shell, the user can install an interface card inside the left-side cover shell directly. Therefore, the invention saves much interface card installation time and labor as well as interface card installation cost.

Further, the mounting panel of the left-side cover shell has a screw hole formed in the top side thereof, and the detachable baffle has a flange perpendicularly forwardly extended from the top side thereof and attached to the top side of the mounting panel of the left-side cover shell. The flange of the detachable baffle has a notch corresponding to the screw hole of the left-side cover shell, the notch fastened to the screw hole with a screw.

Further, the mounting panel may be formed by directly bending the front part of the left-side cover shell into shape. Alternatively, the mounting panel can be separately made, and then riveted to the front side of the left-side cover shell.

### BRIEF DESCRIPTION OF THE DRAWINGS

FIG. 1 is a perspective view of a server according to the prior art.

FIG. 2 is perspective view showing another status of the prior art server after installation of an interface card.

FIG. 3 is an exploded view of the present invention.

FIG. 4 is an assembly view of the present invention before connection between the left-side cover shell and the right-side cover shell.

FIG. 5 is similar to FIG. 4 but showing an interface card installed inside the left-side cover shell after removal of the detachable baffle from the mounting flange of the left-side cover shell.

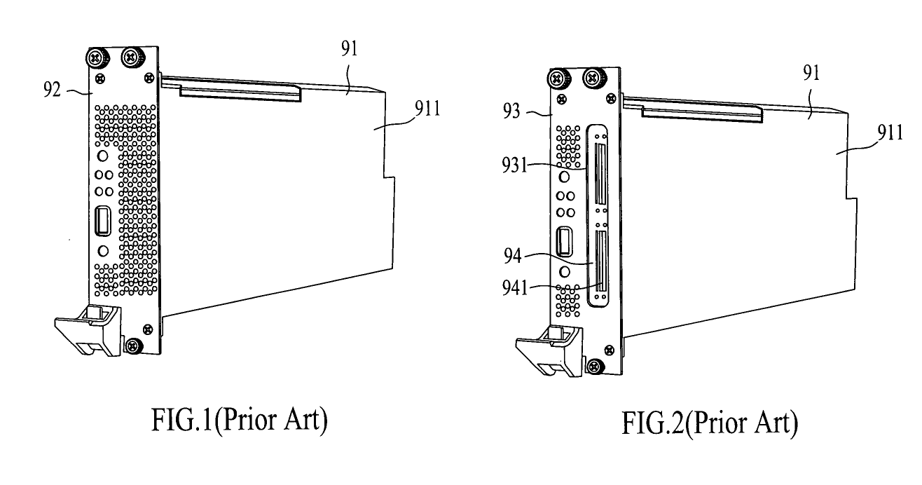

### DETAILED DESCRIPTION OF THE PREFERRED EMBODIMENT

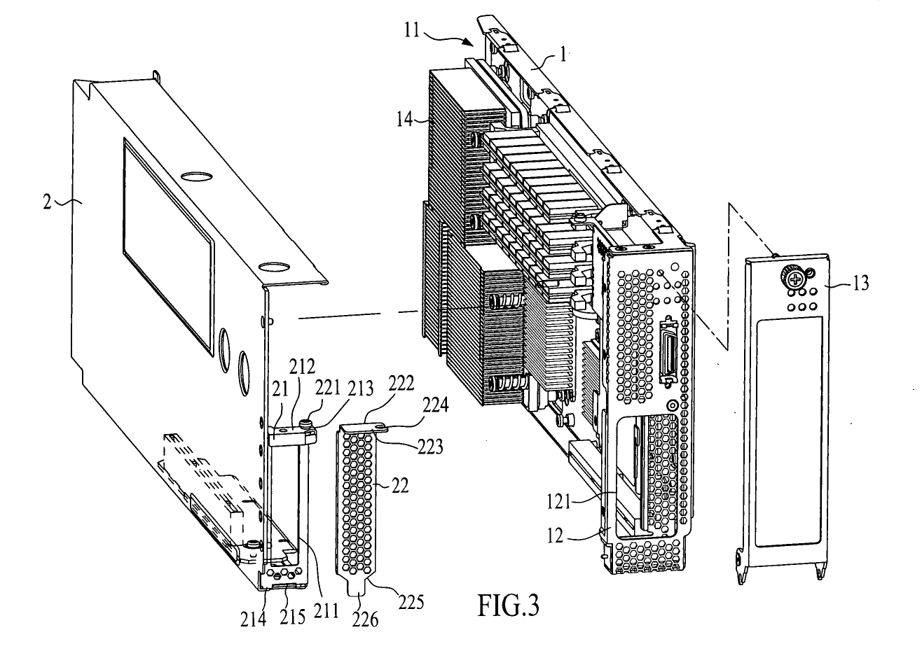

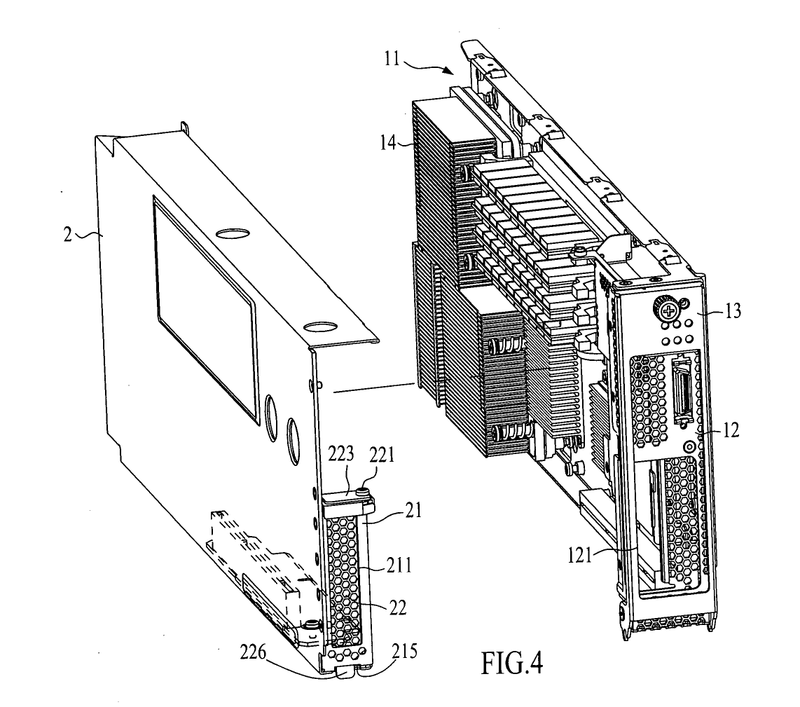

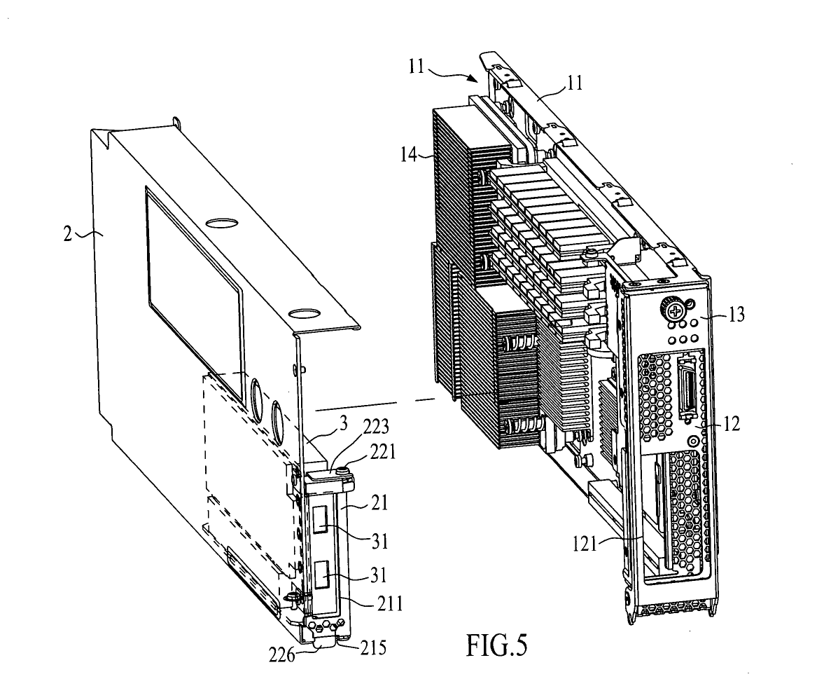

Referring to FIG. 3 and FIG. 4, a blade server is shown for inserting into a server (not shown) in vertical, comprised of a right-side cover shell 1 and a left-side cover shell 2.

The right-side cover shell 1 defines a receiving open chamber 11, which accommodates a variety of electronic devices 14, for example, chips, CPU, and etc. The right-side cover shell 1 has a front panel 12 perpendicularly extended from the front side thereof toward the left side, and an opening 121 formed in the front panel 12. An ornamental plate 13 is installed on the front panel 12 for decoration.

The left-side cover shell 2 is directly covered on the right-side cover shell 1 to close the receiving open chamber 11, having a mounting panel 21 perpendicularly extended from the front side thereof toward the right side. The mounting panel 21 is directly riveted to the left-side cover shell 2 for attaching to the back side of the front panel 12 of the right-side cover shell 1. The mounting panel 21 has an opening 211 corresponding to the opening 121 in the front panel 12 of the right-side cover shell 1.

The left-side cover shell 2 further comprises a detachable baffle 22. The detachable baffle 22 is detachably installed on the mounting panel 21 of the left-side cover shell 2 to close the opening 121 of the front panel 12 of the right-side cover shell 1 and the opening 211 of the mounting panel 21 of the left-side cover shell 2.

According to the present preferred embodiment, the detachable baffle 22 is directly fastened to the mounting panel 21 with a screw 221. The detachable baffle 22 has a flange 223 perpendicularly forwardly extended from the top side 222 thereof, and a locating strip 226 downwardly extended from the bottom side 225. The flange 223 has a notch 224 at one lateral side. The mounting panel 21 of the left-side cover shell 2 has a screw hole 213 formed in the top side 212 thereof and corresponding to the notch 224 of the flange 223, and a locating hole 215 cut through the bottom side 214. During installation, the locating strip 226 of the detachable baffle 22 is directly inserted into the locating hole 215 of the mounting panel 21 of the left-side cover shell 2, and then the screw 221 is inserted through the notch 224 and threaded into the screw hole 213 to lock the detachable baffle 22 to the mounting panel 21 of the left-side cover shell 2.

Referring to FIG. 4, the detachable baffle 22 is used to directly block the opening 121 of the right-side cover shell 1 and the opening 211 of the left-side cover shell 2.

Referring to FIG. 5 and FIG. 3 again, when wishing to install an interface card 3 inside the left-side cover shell 2, detach the left-side cover shell 2 from the right-side cover shell 1, and then loosen the screw 221 from the detachable baffle 22, and then remove the detachable baffle 22 from the mounting panel 21 of the left-side cover shell 2, and then insert the interface card 3 into the inside of the left-side cover shell 2, keeping the two connection ports 31 of the interface card 3 suspending in the opening 211 of the left-side cover shell 2 corresponding to the opening 121 of the right-side cover shell 1 for receiving external connection lines.

Therefore, the design of providing the mounting panel 21 of the left-side cover shell 2 with a detachable baffle 22 can be modularized and applicable to any of a variety types of blade servers. Further, it is not necessary to detach the ornamental plate 13 during installation of an interface card 3. The detachable baffle 22 directly blocks the opening 211 of the left-side cover shell 2 and the opening 121 of the right-side cover shell 1. After removal of the detachable baffle 22 from the mounting panel 21 of the left-side cover shell 2, the user can install an interface card 3 inside the left-side cover shell 2 without removing the ornamental plate 13. Therefore, the invention saves much interface card 3 installation time and labor. Because the design of the present invention has a simple structure, the number of component parts is relatively reduced, resulting in a low manufacturing cost.

Although the present invention has been explained in relation to its preferred embodiment, it is to be understood that many other possible modifications and variations can be made without departing from the spirit and scope of the invention as hereinafter claimed.

What is claimed is:

1. A shell structure for server comprising:
a right-side cover shell defining a receiving open chamber, said right-side cover shell having a front panel perpendicularly extended from a front side thereof toward the left side and an opening formed in said front panel; and
a left-side cover shell covered on said right-side cover shell to close said receiving open chamber, said left-side cover shell having a mounting panel perpendicularly extended from a front side thereof toward the right side and a detachable baffle, said mounting panel having an opening corresponding to the opening in said front panel of said right-side cover shell, said detachable baffle being detachably fastened to said mounting panel to block the opening in said mounting panel of said left-side cover shell and the opening in said front panel of said right-side cover shell.

2. The shell structure for server as claimed in claim 1, further comprising an interface card for installation inside said left-side cover shell, said interface card having at least one connection portion corresponding to the opening in said mounting panel of said left-side cover shell.

3. The shell structure for server as claimed in claim 1, further comprising a screw adapted to secure said detachable baffle to said mounting panel of said left-side cover shell.

4. The shell structure for server as claimed in claim 3, wherein said mounting panel of said left-side cover shell has a screw hole formed in a top side thereof; said detachable baffle has a flange perpendicularly forwardly extended from a top side thereof and attached to the top side of said mounting panel of said left-side cover shell, said flange having a notch corresponding to the screw hole of said left-side cover shell, said notch fastened to said screw hole by said screw.

5. The shell structure for server as claimed in claim 4, wherein said mounting panel of said left-side cover shell has a locating hole formed in a bottom side thereof; said detachable baffle has a locating strip downwardly extended from a bottom side thereof and engaged into the locating hole of said mounting panel of said left-side cover shell.
